(19) United States
(12) Patent Application Publication
(10) Pub. No.: US 2016/0134686 A1
(43) Pub. Date: May 12, 2016

(54) CLOUD MANAGEMENT

(71) Applicant: OTIS ELEVATOR COMPANY, Farmington, CT (US)

(72) Inventors: Jeremy Youker, West Hartford, CT (US); Daryl J. Marvin, Farmington, CT (US); Ronnie E. Thebeau, Haddam, CT (US); Pierre Hardouin, Puteaux (FR)

(21) Appl. No.: 14/896,584

(22) PCT Filed: Jun. 13, 2013
(86) PCT No.: PCT/US2013/045583

§ 371 Date: Dec. 7, 2015

(51) Int. Cl. H04L 29/08; H04L 29/06; H04L 12/911

(52) U.S. Cl. CPC H04L 67/10; H04L 47/823; H04L 63/08

(57) ABSTRACT

Embodiments are directed to a cloud server comprising: at least one processor, and memory having instructions stored thereon that, when executed by the at least one processor, cause the cloud server to: receive data comprising access data that is based on the usage of at least one conveyance device, and transmit the data to a user device.

### BACKGROUND

Current techniques for monitoring the use of vertical transportation systems and conveyance devices (e.g., elevators) make use of capital intensive resources. For example, specialized or dedicated hardware and wiring are used to provide data regarding usage. Many people or entities (e.g., businesses or building owners or operators) are reluctant to invest in such infrastructure due at least in part to high upfront costs. Moreover, the pool of potential users is relatively small, as it can be difficult or even impossible to retrofit the infrastructure in connection with existing transportation systems due to a lack of configurability, customization, and application support. Any features that are developed subsequent to deployment may be difficult to install on an existing transportation system.

### BRIEF SUMMARY

An embodiment is directed to a method comprising: receiving, by a cloud server, data comprising data that is based on the usage of at least one conveyance device, and transmitting, by the cloud server, the data to a user device.

An embodiment is directed to a cloud server comprising: at least one processor, and memory having instructions stored thereon that, when executed by the at least one processor, cause the cloud server to: receive data comprising data that is based on the usage of at least one conveyance device, and transmit the data to a user device.

An embodiment is directed to a system comprising: a plurality of conveyance devices remotely located from one another, and a cloud server configured to receive data comprising data that is based on the usage of the plurality of conveyance devices and transmit the data to a user device.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system;

FIG. 2 illustrates an exemplary block diagram of an elevator system;

FIG. 3 illustrates a flow chart of an exemplary method; and

FIG. 4 illustrates a flow chart of an exemplary method.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for providing management capabilities as a service. The service may be supported by a web browser and may be hosted on servers/cloud technology remotely located from a deployment or installation site. A user (e.g., a customer) may be provided an ability to select which features to deploy. The user may be provided an ability to add or remove units from a portfolio of, e.g., a buildings or campuses from a single computing device. New features may be delivered simultaneously across a wide portfolio base.

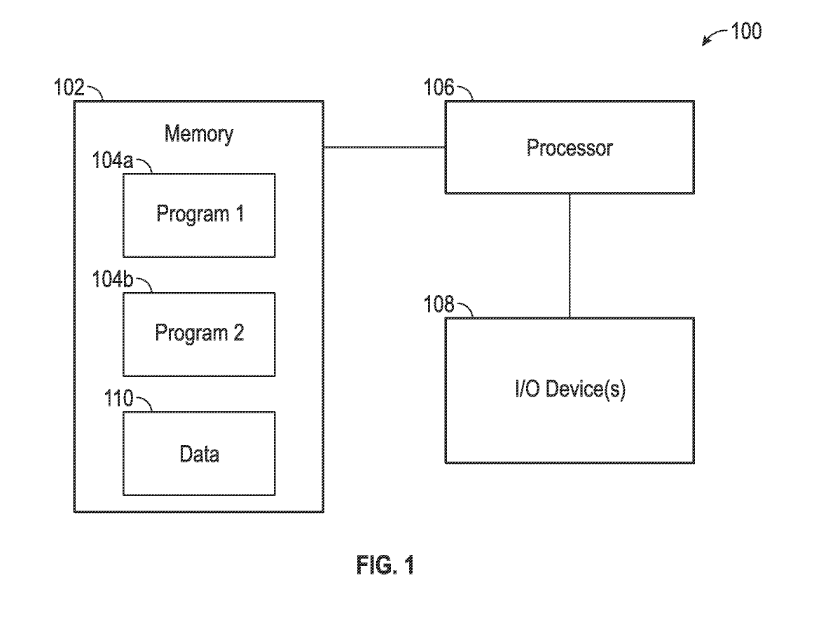

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more applications, processes, routines, procedures, methods, functions, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 108 may be configured to provide an interface to allow a user to interact with the system 100.

The memory 102 may store data 110. The data 110 may include data that may be obtained based on the usage of one or more conveyance devices or systems (e.g., an elevator). The data 110 may include control data that may be used to control the operation of the conveyance devices/systems.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

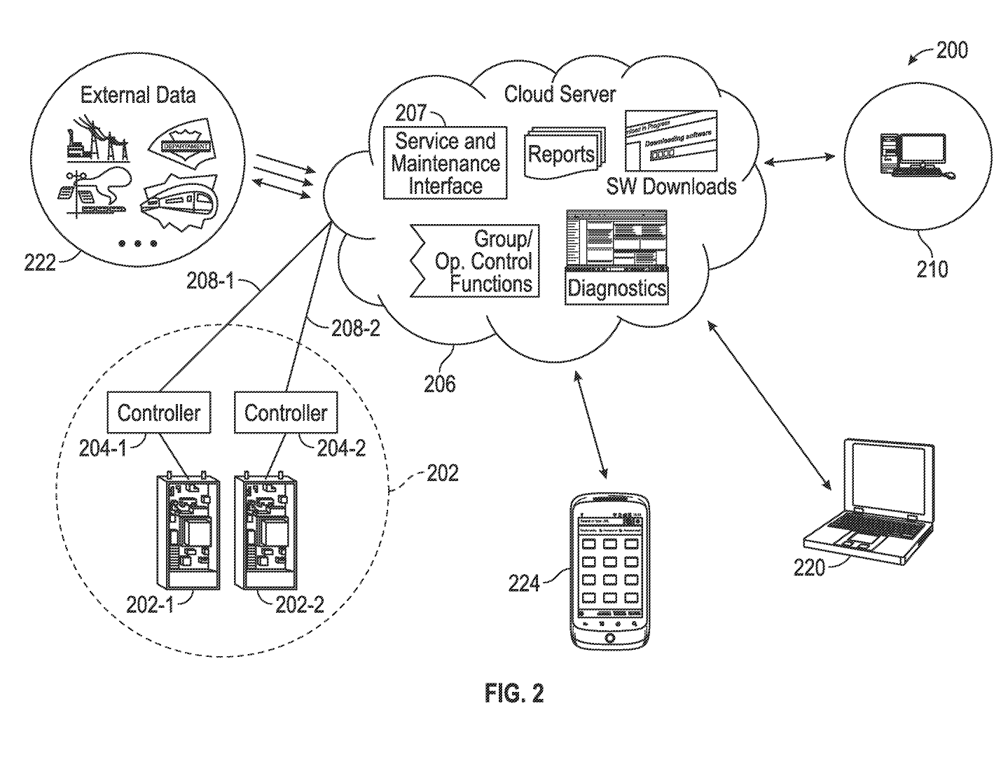

Turning now to FIG. 2, an exemplary system block diagram 200 in accordance with one or more embodiments is shown. As shown in FIG. 2, the system 200 may include one or more conveyance devices, such as escalators, moving walkways, and elevators 202-1 and 202-2. The elevators 202-1 and 202-2 may be included in an elevator group 202. For example, the elevator group 202 may include some or all of the elevators at a particular location, such as a building. Some embodiments may include a mix of various elevators, escalators and moving walkways in a group. While two elevators 202-1 and 202-2 are shown in FIG. 2, an elevator group 202 may include more or less than two elevators. In some embodiments a controller (e.g., controller 204-1) may be integrated in elevator conveyance device (e.g., elevator 202-1).

The elevator group 202 may include one or more controllers, such as controllers 204-1 and 204-2. The controller 204-1 may be associated with the elevator 202-1. The controller 204-2 may be associated with the elevator 202-2. In some embodiments, the controllers 204-1 and 204-2 may be combined, such that a common controller may be associated with each of the elevators 202-1 and 202-2.

In conventional systems, a controller may have been responsible for the operation of an elevator, such as elevators 202-1 and 202-2. In this respect, in conventional systems a controller includes all the hardware, software, wiring, etc., needed to implement functionality (e.g., control functionality or access/monitoring functionality) with respect to elevators that were overseen or regulated by the controller.

In accordance with one or more embodiments of this disclosure, selected controller functionality may be moved or relocated from a controller (e.g., controller 204-1 and/or controller 204-2) to another entity, such as a cloud server 206. Cloud server 206 may include components of computing system 100. By moving functionality to another entity, a reduction in resources (e.g., circuitry) within the controller may be realized. In this respect, controller design may be simplified, which may result in a more reliable controller. Changes in functionality may also be made at one central location (e.g., at the cloud server 206), resulting in a consistent implementation across multiple controllers and/or elevator groups simultaneously and without requiring manual intervention at a local site (e.g., at the elevator group 202). In some embodiments, elevator groups may be remotely located from one another (e.g., in different buildings). The elevator groups may be part of a common portfolio that may be managed by a given entity. Cloud 206 or controller 204-1 and/or 204-2 deployment decision criteria may be available to determine if-and-when new functions are made available to controllers 204-1 and 204-2.

The controller 204-1 and the controller 204-2 may communicate with the cloud server 206 over one or more connections, channels, or links. For example, the controller 204-1 may communicate with the cloud server 206 via a connection 208-1. The controller 204-2 may communicate with the cloud server 206 via a connection 208-2. The connections 208-1 and 208-2 may adhere to one or more communication protocols, standards, or the like. For example, the connections 208-1 and 208-2 may adhere to telephone, cellular, Wi-Fi, Ethernet, satellite, or cable communications. In some embodiments, the connections 208-1 and 208-2 may be constant or persistent.

As described above, functionality may be (re)located to a cloud server (e.g., cloud server 206). Such functionality may include control functions for one or more groups of elevators (e.g., elevator group 202), operational mode determinations, diagnostic functions, special contract features, etc.

In some embodiments, a local controller (e.g., controller 204-1 and/or controller 204-2) may maintain some functionality, and as such, may include hardware and computing resources to support such functionality.

A controller may include hardware and/or software to communicate with a cloud server. For example, a controller may exchange data and commands with the cloud server to perform control functions. The cloud server may store contract setup parameters for select functions. In some embodiments, the contract setup parameters may be stored in the controller. In some embodiments, there may be a simplified failover functionality located in the controller in the event that there is a connection loss between the controller and the cloud server.

In some embodiments, operational metrics may be collected at a cloud server across a portfolio of multiple units, sites, or groups. The metrics may be analyzed by, e.g., a backend computer 210 to provide a broad view of the portfolio. For example, the analysis may indicate trends and may be used to respond to needs (e.g., product needs or functionality needs). The analysis may also be used to facilitate diagnostic or troubleshooting capabilities. Metrics may be used to trigger or enhance the accuracy for future feature enhancements. Metrics may be used to provide or schedule maintenance activities, such as preventative maintenance activities.

In some embodiments, interface protocols for, e.g., new devices may be stored in a cloud server and used by a local controller.

In some embodiments, functional upgrades for diagnostics, prognostics, and remote repair/rescue functions can be deployed to customers as they are released and deployed into a cloud server. Functionality may be developed at the backend computer 210 and deployed to the cloud server 206. One or more tests may be executed to ensure that the functionality satisfies operational or safety requirements.

Once functionality is developed and/or approved for use, the availability of the functionality on the cloud server 206 may be communicated to a user or customer device 220. The user device 220 may be configured to provide an interface to allow a user to select the functionality for deployment on one or more conveyance devices (e.g., elevators 202-1, 202-2), groups (e.g., elevator group 202), etc. In some embodiments, a feature may be available on the basis of payment or agreement to a usage or subscription plan.

The user device 220 may be used to obtain data from, e.g., the cloud server 206. The obtained data may correspond to usage or data for, e.g., one or more conveyance devices, one or more groups, etc. In some embodiments, the obtained data may correspond to historical data (e.g., runtime for an escalator or moving walkway, elevator 202-1 stopped at floor #2 three hundred times in the past thirty days) or real-time data (e.g., elevator 202-1 is currently located at floor #5). The obtained data may be analyzed to provide statistics regarding usage. In some embodiments, the obtained data may include data that is typically external to the operation of an elevator. For example, such external data may include data derived/obtained from one or more data sources 222, such as utilities, security entities or agencies, transportation facilities, emergency services agencies, etc.

In some embodiments, an analysis may be undertaken to develop or establish a relationship between the usage data and the external data, if any such relationship exists. The relationship may serve to generate a prediction for future use of an elevator system, such that a resource associated with the elevator system may be allocated on the basis of the prediction. For example, if a determination is made that the usage data indicates that on days when the temperature exceeds ninety degrees Fahrenheit there were fewer requests for service to the top ten floors of a building relative to the other days when the temperature was less than or equal to ninety degrees Fahrenheit, a consultation of the current temperature may be used to allocate elevator cars to the lower floors of the building if the current temperature is greater than ninety degrees Fahrenheit.

In some embodiments, when the usage data indicates or suggests that there may be an issue or problem associated with, e.g., elevator conveyance device, an indication or alert may be provided to a device 224. The device 224 may correspond to a pager, a mobile device, etc., and may be of a type that may be commonly carried by a mechanic or technician. The mechanic/technician may review the usage/access data, or an analysis of such data as performed by the cloud server 206, to determine a potential cause of the issue or problem and/or a potential remedy or solution for the problem. In some embodiments, a database of historical issues/problems and their accompanying solutions may be maintained by a service and maintenance interface 207 of cloud server 206 and consulted by the device 224 in order to diagnose a current issue/problem. Service and maintenance interface 207 is described in further detail herein.

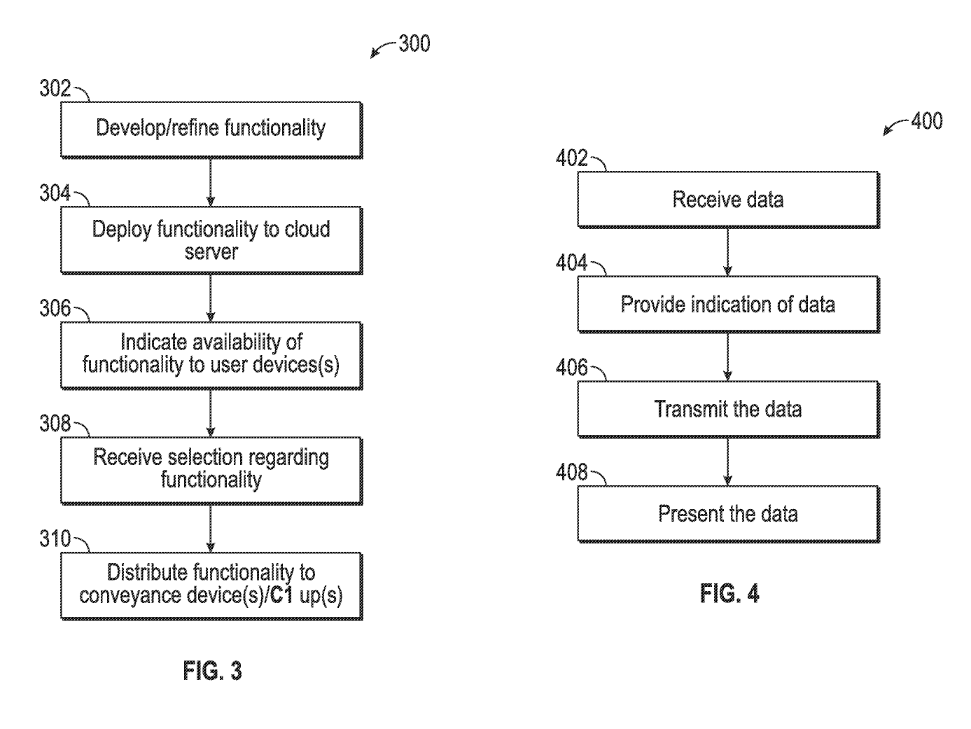

Turning now to FIG. 3, a method 300 is shown. The method 300 may be executed in connection with one or more systems, components, or devices, such as those described herein (e.g., the system 100, the controllers 204-1 and 204-2, the cloud server 206, the backend computer 210, the user device 220, the device 224, etc.). The method 300 may be used to provide for a control of one or more elevators.

In block 302, functionality may be developed. For example, a programmer, an engineer, or the like may develop a computer program to implement one or more operations, functions, or controls (e.g., security controls) with respect to an elevator (e.g., elevator 202-1) or one or more groups of elevators (e.g., group 202). The development may take place in connection with one or more tools or devices, such as the backend computer 210. The functionality may take the form of data. The functionality may correspond to new functionality (e.g., an initial deployment) or refined functionality (e.g., a modification or adaptation made to existing functionality).

In block 304, the functionality developed in block 302 may be deployed to one or more entities, such as the cloud server 206.

In block 306, an indication of the availability of the functionality may be provided to one or more user devices, such as the user device 220. The indication may include pricing information for deploying the functionality on one or more elevators or one or more elevator groups.

In block 308, a selection regarding the functionality may be received. For example, where multiple features are available in connection with the functionality, the selection may identify a subset (or all) of the features for deployment. The selection may identify one or more elevators or elevator groups on which the functionality should be deployed.

In block 310, the functionality may be distributed from the cloud server 206 to one or more conveyance devices (e.g., elevator 202-1) or one or more groups (e.g., elevator group 202) based on the selection of block 308. The distribution of the functionality may include a communication of data between the cloud server 206 and one or more elevator controllers (e.g., controllers 204-1 and 204-2).

Turning now to FIG. 4, a method 400 is shown. The method 400 may be executed in connection with one or more systems, components, or devices, such as those described herein (e.g., the system 100, the controllers 204-1 and 204-2, the cloud server 206, the backend computer 210, the user device 220, the device 224, etc.). The method 400 may be used to provide for a monitoring of one or more conveyance devices.

In block 402, data regarding the usage or operation of one or more conveyance devices or one or more groups may be received by, e.g., the cloud server 206. The received data may include data derived/obtained from external sources 222. The data may be received by the cloud server 206 in response to a request generated by the cloud server 206 (e.g., a “pull-model”). Alternatively, the data may be received by the cloud server 206 as the data becomes available at, e.g., an elevator controller (e.g., a “push-model”).

In block 404, an indication of the received data of block 402 may be provided by the cloud server 206 to, e.g., the user device 220.

In block 406, the data of block 402 may be transmitted from the cloud server 206 to the user device 220. The data may be transmitted to the user device 220 based on the indication of block 404 and in response to a request generated by the user device 220. At least a part of the data transmitted to the user device 220 may have been processed by the cloud server 206.

In block 408, the data of block 406 may be presented on the user device 220. For example, the data may be presented in audible form, as a graphical or textual display, as part of a document, an email, etc., or in any other form or format. As part of block 408, one or more recommendations may be made based on an analysis of the data by service and maintenance interface 207. For example, a maintenance activity may be recommended if, e.g., the data indicates that an elevator is taking a long time to close the elevator car doors once a destination floor has been selected. The recommendations may include a recommendation for deploying a particular function. For example, a function may be available that reduces the amount of time that the elevator doors are open following a selection of a destination floor, which could be used as a temporary solution until the maintenance activity can be performed.

The methods 300 and 400 are illustrative. In some embodiments, one or more blocks or operations (or a portion thereof) may be optional. In some embodiments, the blocks may execute in an order or sequence different from what is shown in FIGS. 3-4. In some embodiments, additional blocks not shown may be included.

Referring to FIG. 2, cloud server 206 may implement a service and maintenance interface 207. Service and maintenance interface 207 may be implemented by cloud server 206 executing a computer program stored in a memory. Service and maintenance interface 207 may be accessed from devices 224 or 220 through a user interface, such as a web browser. Service and maintenance interface 207 can run diagnostics in response to a request from a device. In exemplary embodiments, service and maintenance interface 207 can request that controller 204 run a diagnostic routine stored on controller 204 and provide the results to service and maintenance interface 207. In these embodiments, the diagnostic routine is stored on controller 204. In other embodiments, service and maintenance interface 207 stores diagnostic routines that actively sends commands to a controller 204, receives results from controller 204, and controls the diagnostic actions performed by controller 204. This allows the diagnostic routines in service and maintenance interface 207 to be updated through, for example, backend computer 210.

The computing resources of cloud server 206 provide for enhanced service functions. Service and maintenance interface 207 can collect data from controllers 204 across a large number of installations. Having a cloud connection for service data allows for building a knowledge base based on diagnostics and resulting actions that can allow for expert systems to suggest solutions to issues, including, for example, suggesting replacement parts and providing access to spare parts ordering and logistics. History and change logs can also be tracked by service and maintenance interface 207 to allow for greater fidelity in usage based maintenance.

Access to the functionality of service and maintenance interface 207 may be made through any web enabled device (e.g., smart phone, tablet) via a browser type interface. Encryption and/or login credentials would be used to authenticate the user to only allow access to authorized users. Depending on the login credentials, a different level of access can be provided. For example, a user with a first level of access may only be permitted to analyze service data and run diagnostics for a single installation (e.g., a single building). Another level of access may allow a user to analyze service data and run diagnostics for a across several installations (e.g., a maintenance company). Yet another level of access may allow a user to create or edit diagnostic routines, data analysis routines, report formats, etc. (e.g., a system administrator).

Access to service and maintenance interface 207 may be from anywhere, both within a building (e.g., in elevator cab, top of car, machine room, landings), as well as remote locations (e.g., a service center). This eliminates the need for physical service tool ports that are used in conventional systems. This also reduces the embedded software code required on each elevator component to provide service tool menus and access control. Access to service and maintenance interface 207 may be granted on a subscription basis, generating revenue.

Aspects of the disclosure may be used to easily integrate new properties or locations in connection with an elevator system. For example, if a new building is being brought on-line or into service with respect to an elevator system, features and capabilities associated with other buildings may be leveraged via deployment using a cloud server.

Aspects of the disclosure may be used to control costs. For example, a feature set or functionality may be selectively deployed on one or more elevators or elevator groups. The addition of an elevator or elevator group with respect to a given function or feature may represent a low or incremental cost. Features may be bundled or packaged to further reduce cost.

Aspects of the disclosure may be used to monitor or control an elevator from any number of locations. For example, because features or data may be available in a cloud server, any device that can network with or connect to the cloud server may be used. The cloud server may be accessed over a variety of networks including wired networks, wireless networks, LANs, WANs, NFC, Bluetooh, Internet, etc., either individually or across multiple disparate networks.

Aspects of the disclosure may be used to modify the features associated with a portfolio of elevators. For example, a new feature or function may be instantly deployed to all or a subset of elevators within a portfolio.

Aspects of the disclosure may be used to maintain consistency across elevators within a portfolio. For example, the need to maintain a configuration history or log for each elevator may be eliminated if all of the elevators within a portfolio are maintained at a common configuration.

Aspects of the disclosure may be used to create a common interface across various platforms. Functionality may be developed to support the common interface and any platform specific details or implementation characteristics can be handled separately. In this manner, a rich feature set may be developed at lower cost by expanding the potential pool of contributors to the feature set.

Aspects of the disclosure may be tailored or customized for a specific market. For example, interfaces, features, data, formats may be adapted to adhere to user requirements or specifications.

Aspects of the disclosure may be used to reduce the processing burdens on user devices. For example, processing or analysis may take place at a cloud server, thereby reducing the complexity of user devices.

While some of the examples described herein related to elevators, aspects of this disclosure may be applied in connection with other types of conveyance devices, such as a dumbwaiter, an escalator, a moving sidewalk, a wheelchair lift, etc.

Embodiments of the disclosure may be used to reduce local controller hardware and/or software. For example, functionality may be at least partially supported by one or more servers, such as one or more cloud servers. Increased or upgraded functionality may be provided without impacting local controller memory or processing requirements/capacities. Functionality to be deployed may be selected from a common location and distributed to any number of conveyance devices which may be remotely located from one another. Data regarding the use or operation of the conveyance devices may be received by a computing device at that common location or at any other location.

Embodiments of the disclosure may be tied to one or more particular machines. For example, a controller may be configured to communicate with a cloud server. The cloud server may store data that may be used to control one or more functions associated with an environment or application. The data may be communicated from the cloud server to the controller to support operations within the environment or application. Data regarding the use or operation of a conveyance device may be transmitted from, e.g., the controller to the cloud server, and from the cloud server to a backend computer, a user device, etc.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
receiving, by a cloud server, data comprising data that is based on the usage of at least one conveyance device; and
transmitting, by the cloud server, the data to a user device.

2. The method of claim 1, further comprising:
transmitting, by the cloud server, an indication that the data is available to the user device; and
receiving, by the cloud server, a request for the data based on the transmitted indication,
wherein the cloud server transmits the data to the user device based on the request.

3. The method of claim 1, wherein the at least one conveyance device comprises a plurality of conveyance devices.

4. The method of claim 3, wherein at least two of the plurality of conveyance devices are located in separate buildings.

5. The method of claim 1, wherein the data comprises data that is external to the at least one conveyance device.

6. The method of claim 5, further comprising:
analyzing, by the cloud server, the data and the external data to establish a relationship between the data and the external data;
generating, by the cloud server, a prediction for the use of the at least one conveyance device based on the relationship; and
allocating, by the cloud server, a resource of the at least one conveyance device based on the prediction.

7. The method of claim 1, further comprising:
providing, by the cloud server, a plurality of features to the user device;
receiving, by the cloud server, a selection of at least one of the plurality of features from the user device; and
distributing, by the cloud server, the selected at least one of the plurality of features to a controller associated with the at least one conveyance device.

8. The method of claim 7, further comprising:
receiving, by the cloud server, an identification of a second at least one conveyance device; and
distributing, by the cloud server, the selected at least one of the plurality of features to a second controller associated with the second at least one conveyance device based on the identification.

9. A cloud server comprising:
at least one processor; and
memory having instructions stored thereon that, when executed by the at least one processor, cause the cloud server to:
receive data comprising data that is based on the usage of at least one conveyance device, and
transmit the data to a user device.

10. The cloud server of claim 9, wherein the at least one conveyance device comprises a plurality of conveyance devices.

11. The cloud server of claim 10, wherein at least two of the conveyance devices are located in separate buildings.

12. The cloud server of claim 9, wherein the data comprises data that is external to the at least one conveyance device, wherein the external data is derived from at least one of: a utility, a security entity, a transportation facility, and an emergency services agency.

13. The cloud server of claim 12, wherein the instructions, when executed by the at least one processor, cause the cloud server to:
analyze the data and the external data to establish a relationship between the data and the external data,
generate a prediction for the use of the at least one conveyance device based on the relationship, and
allocate a resource of the at least one conveyance device based on the prediction.

14. The cloud server of claim 9, wherein the instructions, when executed by the at least one processor, cause the cloud server to:
provide a plurality of features to the user device;
receive a selection of at least one of the plurality of features from the user device, and
distribute the selected at least one of the plurality of features to a controller associated with the at least one conveyance device.

15. The cloud server of claim 14, wherein the instructions, when executed by the at least one processor, cause the cloud server to:
receive an identification of a second at least one conveyance device, and
distribute the selected at least one of the plurality of features to a second controller associated with the second at least one conveyance device based on the identification.

16. The cloud server of claim 14, wherein the instructions, when executed by the at least one processor, cause the cloud server to:
receive the plurality of features from a backend computer.

17. A system comprising:
a plurality of conveyance devices remotely located from one another; and
a cloud server configured to receive data comprising data that is based on the usage of the plurality of conveyance devices and transmit the data to a user device.

18. The system of claim 17, wherein the cloud server is configured to receive the data using at least one of: telephone communications, cellular communications, Wi-Fi communications, Ethernet communications, satellite communications, and cable communications.

19. The system of claim 17, wherein the cloud server is configured to receive a set of features from a backend computer, and wherein the cloud server is configured to transmit the set of features to the user device, and wherein the cloud server is configured to a receive a selection of at least one feature included in the set of features from the user device and a selection of at least one of the plurality of conveyance devices, and wherein the cloud server is configured to distribute the selected at least one feature to at least one controller associated with the at least one of the plurality of conveyance devices.

20. The system of claim 17, wherein the cloud server executes a service and maintenance interface, the service and maintenance interface to transmit to the user device a recommendation regarding a maintenance activity to perform on at least one of the conveyance devices based on an analysis of the data.

21. The system of claim 17, wherein the cloud server executes a service and maintenance interface, the user device accessing the service and maintenance interface by providing login credentials.

22. The system of claim 21, wherein the login credentials establish varying levels of access to the service and maintenance interface.

23. The system of claim 21, wherein access to the service and maintenance interface is subscription based.

24. The system of claim 21, wherein the service and maintenance interface maintains a knowledge base based on diagnostics of the conveyance devices and resulting actions, the knowledge base supporting identifying replacement parts, providing access to spare parts ordering and logistics.

25. The system of claim 21, wherein the service and maintenance interface stores maintenance history and change logs for the conveyance devices.

26. The system of claim 21, wherein the service and maintenance interface stores diagnostic routines to evaluate operation of the conveyance devices.

27. The system of claim 17, further comprising:
at least one controller associated with at least one of the conveyance devices, wherein the at least one controller is configured to provide failover functionality in the event that there is a connection loss between the controller and the cloud server.
